(19) United States
(12) Patent Application Publication
(10) Pub. No.: US 2011/0193905 A1
(43) Pub. Date: Aug. 11, 2011

(54) PRINTING DEVICE

(75) Inventor: Toru MIYAMOTO, Shiojiri (JP)

(73) Assignee: SEIKO EPSON CORPORATION, Tokyo (JP)

(21) Appl. No.: 13/018,500

(22) Filed: Feb. 1, 2011

(30) Foreign Application Priority Data
Feb. 9, 2010 (JP) 2010-026260

(51) Int. Cl. B41J 29/38

(52) U.S. Cl. 347/14

(57) ABSTRACT

A printing device includes a plurality of heads, a movement mechanism, and a calculation unit. The heads are configured to print an image on a medium by discharging colored inks onto the medium. The heads discharge the inks at different positions in a predetermined direction. The movement mechanism is configured to move the medium and the heads in the predetermined direction relative to each other. The calculation unit is configured to determine respective discharge amounts of ink discharged from each of the heads when the image is printed. A position in the predetermined direction, in which the inks are discharged from the heads, is varied based on the discharge amounts determined by the calculation unit.

### CROSS-REFERENCE TO RELATED APPLICATIONS

This application claims priority to Japanese Patent Application No. 2010-026260 filed on Feb. 9, 2010. The entire disclosure of Japanese Patent Application No. 2010-026260 is hereby incorporated herein by reference.

### BACKGROUND

1. Technical Field

The present invention relates to a printing device.

2. Related Art

Examples of inkjet printers which use ink to print images include printers that comprise a plurality of heads in a conveying direction, the heads having pluralities of nozzles aligned in a paper width direction, and that print images by discharging ink droplets from the plurality of heads while conveying a medium (e.g., paper) (so-called line printers, see Japanese Laid-Open Patent Publication No. 2007-68202, for example); and printers that alternately perform a dot formation action for forming dots on a medium by discharging ink from heads onto the medium while the heads are moved in a movement direction, and a conveying action for conveying the medium in the conveying direction (serial printers).

### SUMMARY

In a line printer, the printing speed can be improved by increasing the conveying speed. However, when the conveying speed is increased excessively, there is a risk of blurring (hereinbelow also referred to as bleeding) occurring between the inks discharged from the heads aligned in the conveying direction. In the case of serial printers, the time duration of the dot formation action can be shortened by increasing the movement speed of the heads during the dot formation action, and the printing speed can be improved. However, in this case as well, there is a risk of bleeding occurring between inks of different colors when the head movement speed is increased by too much.

In view of this, an object of the present invention is to improve printing speed while minimizing blurring between inks.

A printing device according to one aspect of the invention includes a plurality of heads, a movement mechanism, and a calculation unit. The heads are configured to print an image on a medium by discharging colored inks onto the medium. The heads discharge the inks at different positions in a predetermined direction. The movement mechanism is configured to move the medium and the heads in the predetermined direction relative to each other. The calculation unit is configured to determine respective discharge amounts of ink discharged from each of the heads when the image is printed. A position in the predetermined direction, in which the inks are discharged from the heads, is varied based on the discharge amounts determined by the calculation unit.

Other characteristics of the present invention are made clear in the descriptions of the specification and the accompanying drawings.

### BRIEF DESCRIPTION OF THE DRAWINGS

Referring now to the attached drawings which form a part of this original disclosure:

FIG. 1 is a block diagram showing the configuration of a printing system;

FIG. 2 is a schematic drawing of the area around the printing region of the printer;

FIG. 3 is an explanatory diagram of the process of the printer driver;

FIG. 4 is an explanatory diagram of a comparative example;

FIG. 5 is a schematic drawing of the area around the printing region after the first embodiment has been applied;

FIG. 6 is an explanatory diagram of a modification of the first embodiment;

FIG. 7A is a drawing showing an image printed on a paper S in the second embodiment, FIG. 7B is a diagram showing the correlation between the regions of FIG. 7A and the discharge duties of inks from the heads of the printer;

FIGS. 8A to 8D are diagrams showing the positional relationship between the arrangement of heads of the printer 1 and the heads discharging ink;

FIG. 9 is an explanatory diagram of Modification 1 of the second embodiment;

FIG. 10 is an explanatory diagram of the regions of an image printed in Modification 2 of the second embodiment;

FIG. 11 is a diagram showing the relationship between discharge duty and fixing time of the inks in Modification 2 of the second embodiment;

FIGS. 12A to 12E are explanatory diagrams of the method for calculating conveying speed of Modification 2 of the second embodiment;

FIG. 13 is a perspective view of the printer (a serial printer) of Modification 4 of the second embodiment;

FIG. 14 is a diagram for describing the action in Modification 4 of the second embodiment;

FIG. 15 is a flowchart pertaining to optimizing the conveying speed of the third embodiment;

FIG. 16 is an explanatory diagram of the comparison of scanned images;

FIG. 17 is a diagram showing an example of a change in the conveying speed;

FIG. 18 is a diagram showing the relationship between the conveying speed and the difference in Modification 1 of the third embodiment;

FIG. 19 is a diagram showing an example of the correlation between the size of the difference and the step size in Modification 2 of the third embodiment;

FIG. 20 is a drawing showing a printed image in Modification 3 of the third embodiment; and

FIG. 21 is a drawing showing a bleeding evaluation pattern.

### DETAILED DESCRIPTION OF EXEMPLARY EMBODIMENTS

At least the following aspects are made apparent from the descriptions of the Specification and the accompanying drawings.

Clarified herein is a printing device comprising a plurality of heads for printing an image on a medium by discharging colored inks onto the medium, the heads discharging the inks at different positions in a predetermined direction; a movement mechanism for moving the medium and the plurality of heads in the predetermined direction relative to each other; and a calculation unit for determining the respective amounts of ink discharged from each of the heads when the image is printed; the printing device characterized in that a position in the predetermined direction in which the inks are discharged from the heads is varied based on the discharge amounts determined by the calculation unit.

According to such a printing device, it is possible to improve the conveying speed while minimizing blurring between inks.

In this printing device, it is preferred that each of the heads has a plurality of nozzle rows wherein nozzle rows configured from a plurality of nozzles aligned in a direction intersecting the predetermined direction are aligned in the predetermined direction, and that the nozzle rows used by the heads be varied based on the discharge amounts determined by the calculation unit.

According to such a printing device, the discharge positions of the inks (the positions in the predetermined direction) can be varied without providing a mechanism for moving the heads in the predetermined direction.

In this printing device, it is preferred that the speed of the relative movement between the medium and the plurality of heads is varied based on the discharge amounts determined by the calculation unit.

According to such a printing device, the printing speed can be optimized.

In this printing device, it is preferred that the calculation unit calculates the amount of ink discharged by each of the heads in each of a plurality of regions of the medium, and that the position in the predetermined direction where the inks are discharged from each of the heads be varied according to the amount of ink discharged in each of the plurality of regions.

According to such a printing device, the printing speed can be increased further.

In this printing device, it is preferred that the medium be conveyed in the predetermined direction and the respective inks be discharged from the plurality of heads onto the medium being conveyed; that the printing device comprise a reading unit for reading an image printed on the medium by the heads, and a comparison unit for comparing an image reading result when the medium is conveyed at a reference speed until ink discharged from a given head lands on the medium, and an image reading result when the medium is conveyed at a first conveying speed that is higher than the reference speed, the reference speed being the speed at which ink discharged from another head upstream from the given head in the predetermined direction dries; and a subsequent printing is performed at a second conveying speed that is lower than the first conveying speed when the results of the comparison made by the comparison unit have exceeded an acceptable value.

According to such a printing device, it is possible to optimize the conveying speed while minimizing blurring between inks.

In this printing device, it is preferred that the medium be conveyed in the predetermined direction and the respective inks be discharged from the plurality of heads onto the medium being conveyed; that the printing device comprise a reading unit for reading an image printed on the medium by the heads, and a comparison unit for comparing an image reading result when the medium is conveyed at a reference speed until ink discharged from a given head lands on the medium, and an image reading result when the medium is conveyed at a first conveying speed that is higher than the reference speed, the reference speed being the speed at which ink discharged from another head upstream from the given head in the predetermined direction dries; and a subsequent printing is performed at a second conveying speed that is higher than the first conveying speed when the results of the comparison made by the comparison unit have exceeded an acceptable value.

According to such a printing device, it is possible to optimize the conveying speed while minimizing blurring between inks.

In this printing device, it is preferred that the magnitude of the second conveying speed be established according to the results of the comparison made by the comparison unit.

According to such a printing device, the number of times printing is done with a slow conveying speed can be reduced, and the optimum conveying speed can be established sooner.

In this printing device, it is preferred that the reading unit read part of the image printed on the medium; and that the comparison unit compare a result of reading a part of the image when the medium is conveyed at the reference speed, and a result of reading a part of the image when the medium is conveyed at the first conveying speed.

According to such a printing device, the time duration needed for reading can be reduced.

In the following embodiments, the descriptions use an inkjet printer (hereinbelow also referred to as the printer 1) as an example.

### Configuration of Printing System

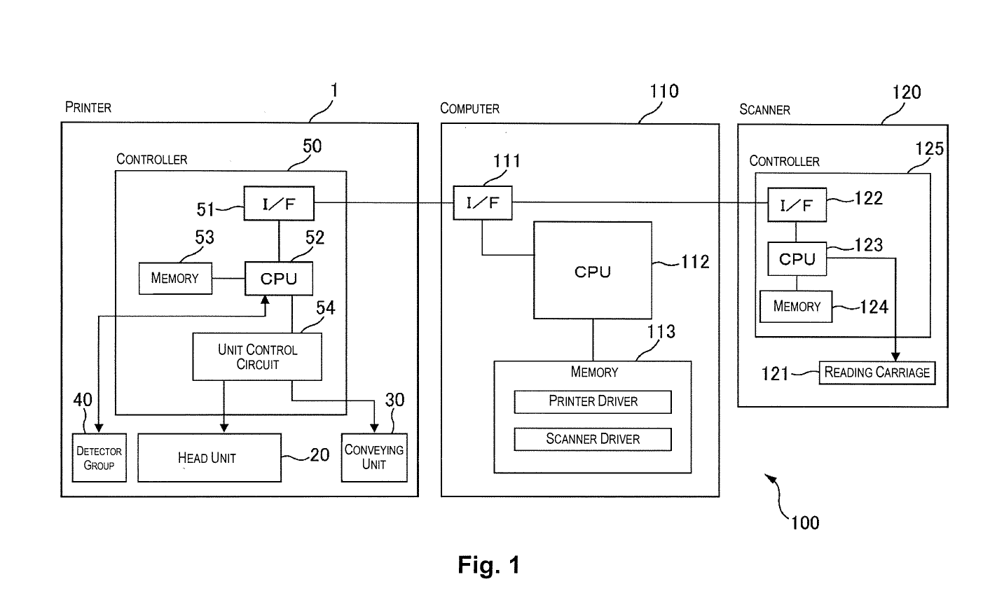

FIG. 1 is a block diagram showing the configuration of a printing system 100.

The printing system 100 of the present embodiment is a system having a printer 1, a computer 110, and a scanner 120, as shown in FIG. 1.

The printer 1 is a liquid discharge device for discharging ink as a liquid onto a medium and forming an image on the medium, and is a color inkjet printer in the present embodiment. The printer 1 is capable of printing images on various types of mediums, including paper, cloth, film sheets, and the like. In the present embodiment, printing is performed on a paper S as the medium.

The computer 110 is communicably connected with the printer 1 via an interface 111, and in order to print an image in the printer 1, print data corresponding to the image is outputted to the printer 1. The computer 110 is provided with a CPU 112 for running various programs installed in the computer 110, and a memory 113 for storing the various programs. Among the programs installed in the computer 110 are a printer driver for converting the image data outputted from an application program into print data, and a scanner driver for controlling the scanner 120 which is communicably connected to the computer 110 via the interface 111.

The scanner 120 is a device for radiating light onto the paper S which has been conveyed to a platen (not shown), detecting the reflected light using a sensor (e.g. a CCD sensor; not shown) provided to a reading carriage 121, reading the image of the paper S, and acquiring information on the colors of the image.

The scanner 120 reads the image by causing a line sensor (e.g. a CCD sensor), which is aligned, for example, in a primary scanning direction, to move in a secondary scanning direction. This line sensor has, for example, a sensor for detecting red (R) light, a sensor for detecting green (G) light, and a sensor for detecting blue (B) light. The scanner 120 obtains information (read gradation values) on the three colors red (R), green (G), and blue (B) by irradiating light onto the paper S and detecting (color-separating) the reflected light using the sensors.

This scanner 120 comprises a controller 125 having an interface 122, a CPU 123, and a memory 124, and transmits data indicating the color information of the image to the scanner driver of the computer 110 via the interface 122.

The term “printing device” means the printer 1 in a strict sense, but in a broader sense means the system including the printer 1, the computer 110, and the scanner 120.

### Configuration of Printer 1

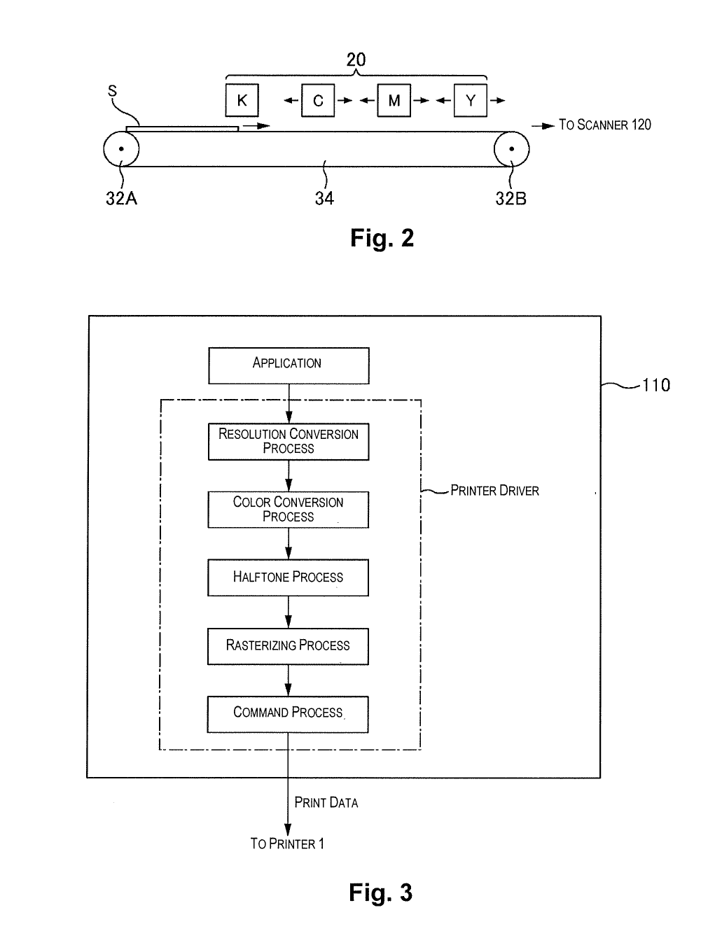

Next, the configuration of the printer 1 is described while referring to FIGS. 1 and 2.

FIG. 2 is a schematic drawing of the area around the print region of the printer 1. The printer 1 has a head unit 20, a conveying unit 30, a detector group 40, and a controller 50, as shown in FIG. 1. When the printer 1 receives print data from the computer 110, the controller 50 controls the units (the head unit 20 and the conveying unit 30) on the basis of the print data and prints an image on the print medium. The conditions in the printer 1 are monitored by the detector group 40, and the detector group 40 outputs signals corresponding to the detection results to the controller 50.

The purpose of the head unit 20 is to discharge ink onto the paper S. The head unit 20 forms dots on the paper S and prints an image on the paper S by discharging ink onto the paper S being conveyed. The printer 1 of the present embodiment is a line printer, and the head unit 20 is capable of forming dots across the width of the paper all at once.

The head unit 20 of the present embodiment has a black ink head K for discharging black ink, a cyan ink head C for discharging cyan ink, a magenta ink head M for discharging magenta ink, and a yellow ink head Y for discharging yellow ink, as shown in FIG. 2.

These heads are disposed in alignment at equal intervals (e.g., intervals of 10 inches) in the order of the black ink head K, the cyan ink head C, the magenta ink head M, and the yellow ink head Y from the upstream side of the conveying direction.

In the present embodiment, the cyan ink head C, magenta ink head M, and yellow ink head Y for discharging the inks of the different colors are capable of moving independently upstream or downstream in the conveying direction in accordance with instructions from the controller 50, as shown in the drawings.

The heads are provided with nozzle rows in which pluralities of nozzles for discharging the inks are aligned in the paper width direction. A row of dots aligned in the direction in which the heads and paper move relative to each other is referred to as a “raster line.” In the case of a line printer as in the present embodiment, the term “raster line” means a row of dots aligned in the conveying direction of the paper. In the case of a serial printer which prints by a head mounted on a carriage, the term “raster line” means a row of dots aligned in the movement direction of the carriage. The printed image is configured by the alignment of numerous raster lines in a direction perpendicular to the movement direction.

The purpose of the conveying unit 30 (equivalent to the movement mechanism) is to convey the medium (e.g. the paper S or the like) in the conveying direction. This conveying unit 30 has an upstream roller 32A, a downstream roller 32B, and a belt 34. When a conveying motor (not shown) rotates, the upstream roller 32A and the downstream roller 32B rotate, and the belt 34 rotates. The supplied paper S is conveyed by the belt 34 to a region where printing can be performed (a region facing the heads). The belt 34 conveys the paper S, whereby the paper S moves in the conveying direction relative to the head unit 20. The paper S being conveyed is held to the belt 34 by electrostatic adhesion or vacuum adhesion. Paper S that has passed through the printable region is ejected by the belt 34 and then conveyed by a belt (not shown) to the scanner 120.

The controller 50 is a control unit for performing control of the printer. The controller 50 has an interface unit 51, a CPU 52, a memory 53, and a unit control circuit 54, as shown in FIG. 1. The interface unit 51 conducts the sending and receiving of data between the computer 110, which is an external device, and the printer 1. The CPU 52 is a computation processing device for performing control of the entire printer. The purpose of the memory 53 is to reliably provide regions for storing the programs of the CPU 52, operative regions, and the like, and the memory 53 has a RAM, an EEPROM, and other storage elements. The CPU 52 controls the units via the unit control circuit 54 in accordance with the programs stored in the memory 53.

### Printing Process

In this type of printer 1, when the controller 50 receives print data, the controller 50 first rotates a paper-feeding roller (not shown) using the conveying unit 30 and feeds the paper S to be printed onto the belt 34. The paper S is conveyed over the belt 34 at a constant speed without stopping, and passes under the heads of the head unit 20. While the paper S is passing under the head unit 20, ink is intermittently discharged from the nozzles of the heads. In other words, the dot formation process and the paper S conveying process are performed simultaneously. As a result, dot rows composed of pluralities of dots along the conveying direction and the paper width direction are formed on the paper S, and an image is printed.

### Summary of the Process of the Printer Driver

The printing process described above is initiated by print data being sent from the computer 110 connected to the printer 1, as previously described. This print data is created by a process performed by the printer driver. The process of the printer driver is described hereinbelow while referring to FIG. 3. FIG. 3 is an explanatory diagram of the process of the printer driver.

The printer driver receives image data from an application program, converts this data into a form of print data that can be interpreted by the printer 1, and outputs the print data to the printer. When the image data from the application program is converted to print data, the printer driver performs a resolution conversion process, a color conversion process, a halftone process, a rasterizing process, a command-annexing process, and the like.

The resolution conversion process is a process for converting image data (text data, image data, etc.) outputted from the application program into a resolution (print resolution) of printing on the paper. For example, when the print resolution is specified as 720×720 dpi, the image data of the vector format received from the application program is converted to bitmap format image data whose resolution is 720×720 dpi. The different types of image data of the image data that has undergone the resolution conversion process is multiple (e.g. 256)-tone RGB data expressed by RGB color spaces.

The color conversion process is a process for converting RGB data into CMYK color space data. CMYK color space image data is data corresponding to the colors of the ink of the printer. In other words, the printer driver creates CMYK planar image data on the basis of RGB data.

This color conversion process is performed based on a table correlating the tone values of RGB data with the tone values of CMYK data (a color conversion look-up table LUT). Image data that has undergone the color conversion process is 256 tone CMYK data expressed by CMYK color spaces.

The halftone process is a process for converting high-tone data into data of a tone that can be formed by the printer. Through this halftone process, data showing 256 tones is converted to 1-bit data showing 2 tones or 2-bit data showing 4 tones. In the image data that has undergone the halftone process, 1-bit or 2-bit image data corresponds to every pixel, and this pixel data is data showing the dot formation conditions (whether or not there is a dot, the size of the dot) in all the pixels. For example, in the case of 2 bits (4 tones), the data is converted to 4 tones as in the formation not of dots corresponding to a dot tone value of [00], but of small dots corresponding to a dot tone value of [01], medium dots corresponding to a dot tone value of [10], and large dots corresponding to a dot tone value of [11]. A dot creation rate is then established for the size of the dots, and a dither method, γ correction, error diffusion, or another method is used to create pixel data so that the printer 1 distributes and forms dots.

In the rasterizing process, the pixel data arranged in a matrix is sorted for every pixel data in the order of data to be transferred to the printer 1. For example, the pixel data is sorted according to the arranged sequence of nozzles of the heads.

The command-annexing process is a process whereby command data corresponding to the printing setup is annexed to the data that has undergone the rasterizing process. An example of command data is conveying data that indicates the conveying speed of the medium.

The print data created through these processes is sent to the printer 1 by the printer driver.

### Blurring Between Inks

In the printer 1 described above, printing can be improved by increasing the conveying speed of the paper S. However, if the conveying speed is increased excessively, there is a risk that blurring (hereinbelow also referred to as bleeding) will occur between the inks discharged from heads aligned in the conveying direction, which may be the cause of poor image quality.

For example, when a blue image is printed on the paper S, cyan ink and magenta ink are used. First, cyan ink is discharged from the cyan ink head C when the paper S being conveyed in the conveying direction passes underneath the cyan ink head C. Magenta ink is then discharged from the magenta ink head M when the paper S on which cyan ink has been deposited passes underneath the magenta ink head M. At this time, if the conveying speed is too fast, the magenta ink is deposited on the paper S before the cyan ink dries, and there will be bleeding between the cyan ink and the magenta ink.

### Comparative Example

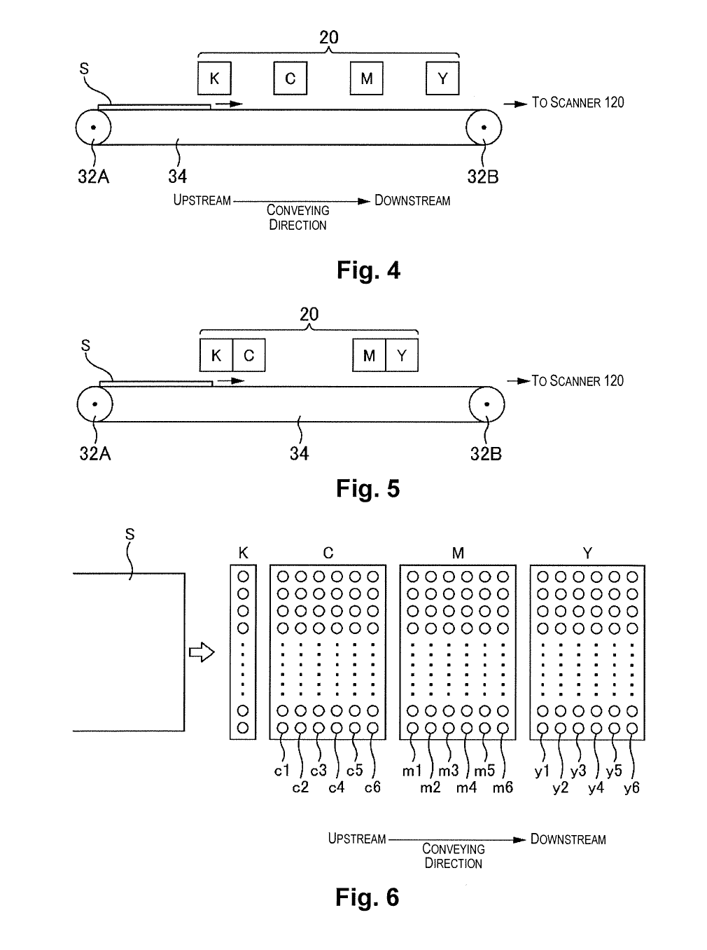

FIG. 4 is an explanatory diagram of a comparative example of the present embodiment. In the comparative example shown in FIG. 4, the black ink head K, the cyan ink head C, the magenta ink head M, and the yellow ink head Y are disposed at equal intervals, and the positions in the conveying direction where the inks are discharged from the heads are fixed.

For example, when printing is performed with 100% ink discharge duty from the cyan ink head C, assuming six seconds are needed for the 100% duty ink to fix (dry), six seconds must be taken to convey 10 inches to the magenta ink head M. The term “duty” refers to the ratio of the ink discharge amount when large dots are formed over 100% of the pixels in the entire paper S.

In this case, assuming there are 10 inch intervals between heads, for example, the conveying speed must be 10 (inch)/6 (sec)=16.6 (cps) or less.

The relationship between the ink discharge amount and drying time differs depending on the type of paper S. Therefore, to prevent bleeding from occurring regardless of the type of paper S or ink, the conveying speed must be lowered to a speed whereby the ink dries between heads and it is not possible to increase the conveying speed to the optimum speed, even under the worst possible conditions (cases in which paper is used on which ink does not dry readily and cases in which the ink discharge amount is high).

In view of this, in the present embodiment, the conveying speed can be optimized while suppressing bleeding. In subsequent embodiments, the same image (or a partially similar image) is printed on multiple sheets of paper S.

### First Embodiment

In the comparative example previously described, the intervals between heads in the conveying direction have been equal. In the present embodiment, however, the cyan ink head C, magenta ink head M, and yellow ink head Y for discharging the colored inks are capable of moving independently upstream and downstream in the conveying direction as previously described. In the printer 1 of the present embodiment, the positions of the heads in the conveying direction are varied according to the print data received from the computer 110. In other words, the positions where inks are discharged from the heads (the positions in the conveying direction) are varied.

From the print data received from the computer 110, the controller 50 (equivalent to the calculation unit) of the printer 1 of the present embodiment calculates the discharge duty of the different ink colors that have undergone the halftone process. The controller 50 varies the positions of the heads in the conveying direction on the basis of the calculated duty (the duty of each ink color).

For example, when an image that does not use red (a mixture of magenta and yellow) is printed on the paper S, the interval between the magenta ink head M and the yellow ink head Y may be small.

In this case, the controller 50 of the printer 1 then moves the cyan ink head C which discharged cyan ink upstream in the conveying direction and moves the yellow ink head Y which discharges yellow ink upstream in the conveying direction on the basis of the image print data, as in FIG. 5. FIG. 5 is a schematic drawing of the area surrounding the printing region after the first embodiment has been applied. This makes it possible for the interval between the cyan ink head C and the magenta ink head M and the interval between the cyan ink head C and the yellow ink head Y to be larger than in FIG. 4, and also makes bleeding between cyan ink and magenta ink and bleeding between cyan ink and yellow ink less likely to occur. The interval between the yellow ink head Y and the paper discharge can also be larger than in FIG. 4. This can prevent ink from adhering even if ejected papers S overlap.

Thus, by varying the positions at which inks are discharged from the heads in accordance with the print data, the incidence of bleeding can be reduced. It is thereby possible to increase the conveying speed to be higher than the maximum conveying speed when the intervals between the heads are equal (FIG. 4), and the printing speed can be improved.

### Modification of First Embodiment

In the first embodiment previously described, the heads were moved in the conveying direction, but in this modification, the heads are provided with pluralities of nozzle rows aligned in the conveying direction, and the nozzle rows used in the heads are varied according to the image duties.

FIG. 6 is an explanatory diagram of the modification of the first embodiment. In this modification, as illustrated, the cyan ink head C is provided with six nozzle rows in the conveying direction (in order of c1 to c6 from the upstream side), the nozzle rows consisting of pluralities of nozzles for discharging ink aligned in the paper width direction.

Similarly, the magenta ink head M is also provided with six (m1 to m6) nozzle rows aligned in the conveying direction, and the yellow ink head Y is also provided with six (y1 to y6) nozzle rows aligned in the conveying direction.

According to the duty based on the print data, the controller 50 of the printer 1 selects the nozzle rows that will eject ink from among the pluralities of nozzle rows of the heads.

For example, when an image that does not use red (a mixture of magenta and yellow) is printed on the paper S, the controller 50 selects a nozzle row upstream in the conveying direction (e.g., the nozzle row c1) in the cyan ink head C, selects a nozzle row downstream in the conveying direction (e.g., the nozzle row m6) in the magenta ink head M, and selects a nozzle row upstream in the conveying direction (e.g., the nozzle row y1) in the yellow ink head Y. The positions where inks are discharged from the heads (the positions in the conveying direction) can thereby be varied without moving the heads in the conveying direction.

In this modification, the ink discharge positions (positions in the conveying direction) can be varied without providing a mechanism for moving the heads in the conveying direction. In this case as well, since the conveying direction of the paper S can be increased above that of the comparative example, it is possible to improve the printing speed while suppressing bleeding.

### Second Embodiment

In the second embodiment, the conveying speed is optimized according to the discharge duty of inks in each region of the paper S.

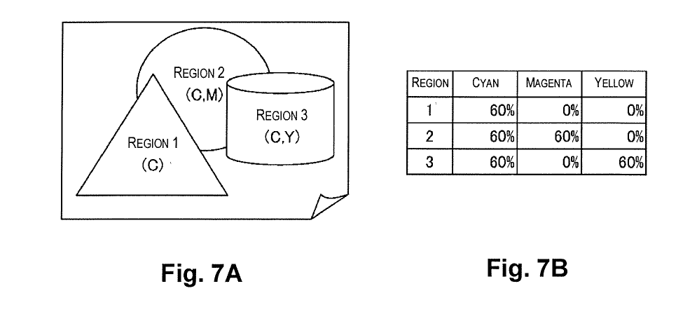

FIG. 7A is a drawing showing an example of an image printed on the paper S in the second embodiment. FIG. 7B is a drawing showing the correlation between the regions in FIG. 7A and the discharge duties of inks from the heads of the printer 1.

For example, region 1 is printed in cyan. In this region 1, cyan ink alone is discharged with a duty of 60% as shown in FIG. 7B. Region 2 is printed in blue. In this region 2, cyan ink and magenta ink are both discharged with a duty of 60% as shown in FIG. 7B. Region 3 is printed in green. In this region 3, cyan ink and yellow ink are both discharged with a duty of 60% as shown in FIG. 7B.

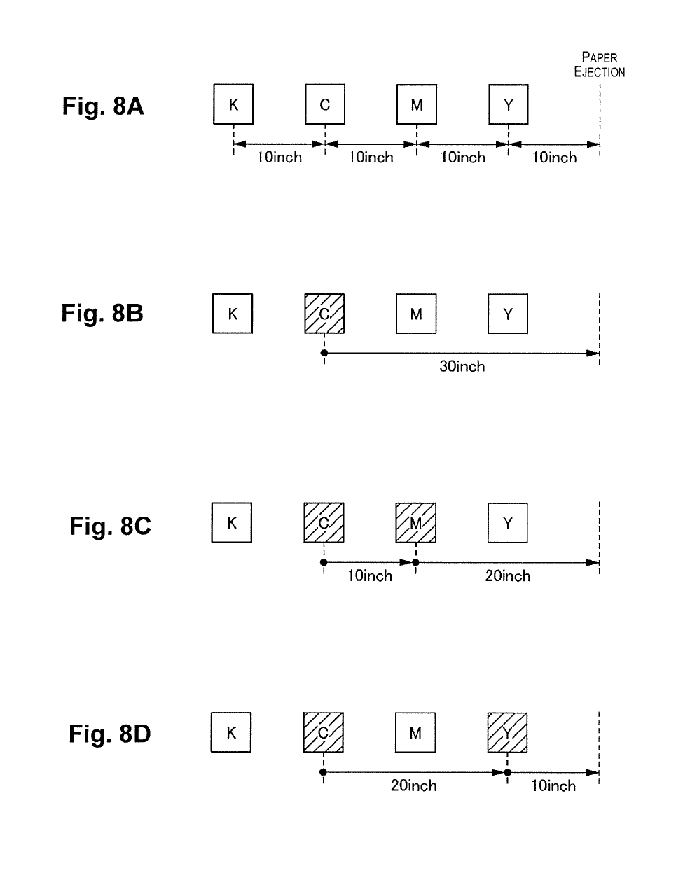

FIGS. 8A to 8D are drawings showing the arrangement of heads in the printer 1 and the positional relationship between the heads that discharge ink. In these drawings, the heads that discharge ink are shown with diagonal lines.

In the present embodiment, the black ink head K, the cyan ink head C, the magenta ink head M, and the yellow ink head Y are disposed at 10 inch intervals from each other as shown in FIG. 8A. If the paper S is conveyed at a conveying speed of 100 cps, the time needed for the paper S to pass between adjacent heads is 10 (inch)/100 (cps)=1 (sec).

An image is formed from cyan ink in region 1 in FIG. 7A. Assuming only this region 1 is printed, ink is discharged from the cyan ink head C with a duty of 60% as shown in FIG. 8B. After ink has been discharged from the cyan ink head C, the paper S is conveyed 30 inches in the conveying direction to ejection.

In this case, assuming the time needed for 60%-duty ink to fix (dry) is 3 seconds, the paper is preferably conveyed 30 inches in 3 seconds. Specifically, the paper can be conveyed at 30 (inch)/3 (sec)=100 (cps).

An image is formed from cyan ink and magenta ink in region 2 of FIG. 7A. Assuming only this region 2 is printed, ink is discharged with a duty of 60% from both the cyan ink head C and the magenta ink head M as shown in FIG. 8C. In this case, the cyan ink must fix (dry) by the time the magenta ink is deposited on the paper S. Specifically, at least 3 seconds (the time needed for 60% duty ink to fix) must be taken for the paper to be conveyed the 10 inches between the cyan ink head C and the magenta ink head M. Consequently, the fastest possible conveying speed between these heads is 10 (inch)/3 (sec)=33.3 (cps). At least 3 seconds must be taken to convey the paper 20 inches to ejection after the discharge of magenta ink. Consequently, the fastest possible conveying speed here is 20 (inch)/3 (sec)=66.6 (cps).

In region 3 of FIG. 7A, an image is formed from cyan ink and yellow ink. Assuming only region 3 is printed, ink is discharged with a duty of 60% from both the cyan ink head C and the yellow ink head Y as shown in FIG. 8D. In this case, the cyan ink must fix (dry) by the time the yellow ink is deposited on the paper S. Specifically, at least 3 seconds must be taken for the paper to be conveyed the 20 inches between the cyan ink head C and the yellow ink head Y. Consequently, the fastest possible conveying speed between these heads is 20 (inch)/3 (sec)=66.6 (cps). At least 3 seconds must be taken to convey the paper 10 inches to ejection after the discharge of yellow ink. Consequently, the fastest possible conveying speed here is 10 (inch)/3 (sec)=33.3 (cps).

To print so that bleeding does not occur between these three regions 1 through 3, the paper is preferably conveyed with the lowest conveying speed (33.3 cps) of the conveying speeds determined as described above.

In the present embodiment, since the conveying speed is established according to the discharge duty of inks to the regions of the printed image, when printing is performed with a maximum ink discharge duty of 60%, for example, it is possible to achieve a more appropriate conveying speed (33.3 cps) than the conveying speed (16.6 cps) determined in the comparative example previously described.

The conveying speed can thereby be increased further, and it is possible to optimize the conveying speed while suppressing bleeding.

### Modification 1 of Second Embodiment

In Modification 1 of the second embodiment, the positions of the heads (the positions in the conveying direction) are varied in the same manner as in the first embodiment. In this Modification 1, the same image as that of FIG. 7A is printed, and the discharge duties of inks into the regions is the same as in FIG. 7B. The fixing time of ink with a duty of 60% is 3 seconds, the same as the second embodiment.

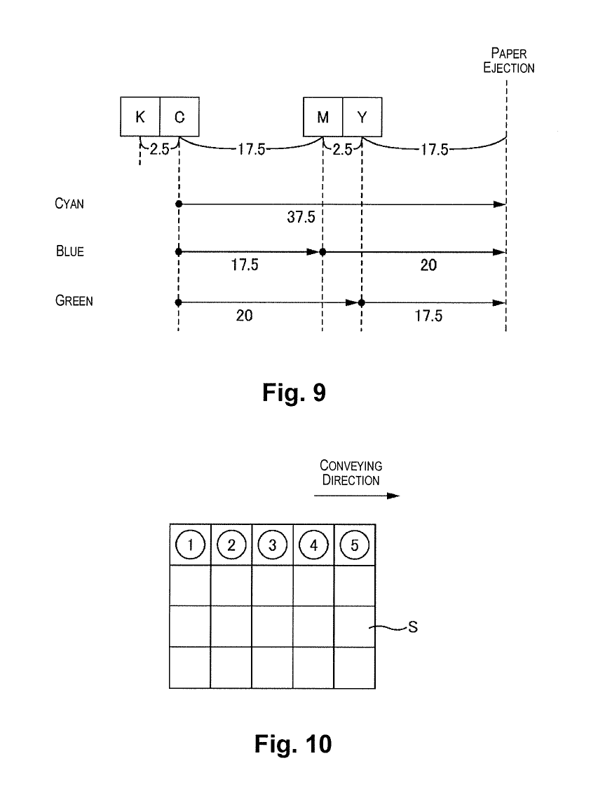

FIG. 9 is an explanatory diagram of Modification 1 of the second embodiment. Thus, by moving the cyan ink head C and the yellow ink head Y upstream in the conveying direction, the conveying distance is 37.5 inches to ejection after the discharge of cyan. Consequently, when only cyan is printed as in region 1 of FIG. 7A, the conveying speed to ejection is 37.5 (inch)/3 (sec)=125 (cps).

The interval between the cyan ink head C and the magenta ink head M is 17.5 inches, and between the magenta ink head M and paper ejection is 20 inches. Consequently, when blue is printed as in region 2 in FIG. 7A, at least 3 seconds must be taken to convey the paper 17.5 inches between the cyan ink head C and the magenta ink head M. Consequently, the fastest possible conveying speed in this region is 17.5 (inch)/3 (sec)=58.3 (cps). At least 3 seconds must be taken to convey the paper 20 inches to ejection after the discharge of magenta ink. Consequently, the fastest possible conveying speed here is 20 (inch)/3 (sec)=66.6 (cps).

The interval between the cyan ink head C and the yellow ink head Y is 20 inches, and between the yellow ink head Y and paper ejection is 17.5 inches. Consequently, when green is printed as in region 3 in FIG. 7A, at least 3 seconds must be taken to convey the paper 20 inches between the cyan ink head C and the yellow ink head Y. Consequently, the fastest possible conveying speed in this region is 20 (inch)/3 (sec)=66.6 (cps). At least 3 seconds must be taken to convey the paper 17.5 inches to ejection after the discharge of yellow ink. Consequently, the fastest possible conveying speed here is 17.5 (inch)/3 (sec)=58.3 (cps).

Consequently, when the image of FIG. 7A is printed, the controller 50 performs the calculation as described above and selects the lowest conveying speed from among the determined conveying speeds. In this case, the conveying speed is 58.3 (cps). This is faster than the speed 33.3 (cps) determined in the second embodiment. Thus, it is possible to further increase the conveying speed by moving the heads. Instead of moving the heads, a plurality of nozzle rows may be provided to the heads in the conveying direction and the nozzle rows that will be used by the heads during printing may be selected, as in the modification of the first embodiment.

### Modification 2 of Second Embodiment

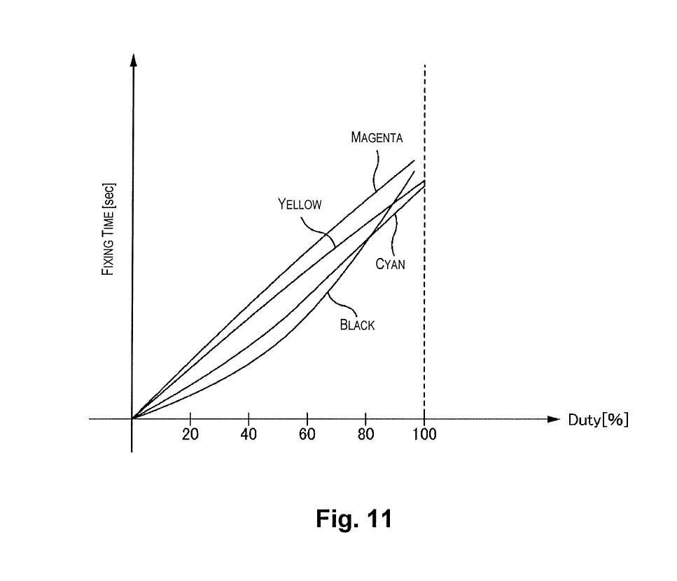

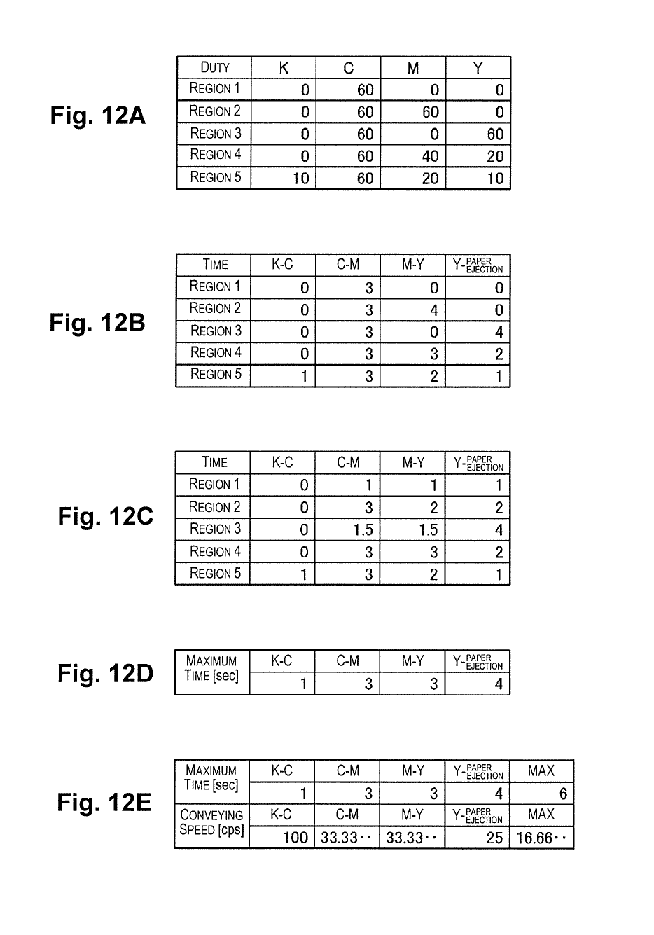

In Modification 2 of the second embodiment, the calculation method for determining the conveying speed from the duty of the inks is different from that of the previously described embodiments. FIG. 10 is an explanatory diagram of the regions of the image printed in Modification 2 of the second embodiment, and FIG. 11 is a graph showing the relationship between the ink discharge duties and fixing times in Modification 2 of the second embodiment. FIGS. 12A through 12E are explanatory diagrams of the method for calculating the conveying speed in Modification 2 of the second embodiment. In FIG. 11, the horizontal axis represents ink discharge duty, and the vertical axis represents the fixing (drying) time of the inks on the paper S. The time needed for drying differs depending on the ink color even if the duty is the same, as shown in the diagrams.

In this Modification 2 of the second embodiment, the paper S is divided into a grid of a plurality of regions, as shown in FIG. 10. In the present embodiment, the optimal conveying speed is determined from the five regions, region 1 through region 5, aligned in the conveying speed among this plurality of regions.

First, the controller 50 calculates the ink discharge duties into the regions from the image print data (data that has undergone the halftone process) (FIG. 12A). For example, in region 1, only cyan ink is discharged with a duty of 60%. In region 4, cyan ink is discharged with a duty of 60%, magenta ink is discharged with a duty of 40%, and yellow ink is discharged with a duty of 20%.

Next, the fixing times of the inks in the different regions are calculated (FIG. 12B) from the relationship between ink duty and fixing time shown in FIG. 11. For example, in region 1, since cyan ink is discharged with a duty of 60%, a fixing time of 3 seconds is required until the next head (the magenta ink head M), according to FIG. 11. In region 2, since cyan ink and magenta ink are both discharged with a duty of 60%, a fixing time of 3 seconds is required from the cyan ink head C to the magenta ink head M, and a fixing time of 4 seconds is required from the magenta ink head M to the yellow ink head Y.

In the regions of FIG. 12B, when there is a head that does not discharge ink, the fixing time of the head upstream in the conveying direction from this non-discharging head is equally divided (FIG. 12C). For example, in region 1, the duties of the magenta ink head M and the yellow ink head Y are 0% according to FIG. 12A. In this case, the time needed (three seconds) for fixing of the cyan ink (a duty of 60%) discharged from the cyan ink head C upstream in the conveying direction is divided equally among the heads (one second each). In region 2, the duty of the yellow ink head Y is 0%. In this case, the time needed (four seconds) for fixing of the magenta ink (a duty of 60%) discharged from the magenta ink head M upstream in the conveying direction from the yellow ink head Y is divided equally (divided by two), as shown in FIG. 12C.

After this process of equally dividing the fixing times has been performed, the maximum time is determined from among the fixing times calculated for each head (FIG. 12D).

The minimum required conveying speeds between heads is then determined from the relationship between the intervals between heads and the maximum time (FIG. 12E), and the lowest conveying speeds are determined from these determined conveying speeds. In FIG. 12E, a conveying speed of 33.3 cps is possible from the cyan ink head C to the magenta ink head M. A conveying speed of 25 cps is possible from the yellow ink head Y to paper ejection. Of these, the lowest speed is 25 cps. The term “MAX” in the diagram refers to the conveying speed when the discharge duty of a certain ink color is 100% and 6 seconds are required for fixing (a comparative example). In this case, the maximum value of the conveying speed is 10 (inch)/6 sec=16.66 . . . (cps) as previously described. Thus, in the present embodiment, the conveying speed can be increased to be greater (25 cps) than this conveying speed, and it is possible to improve the conveying speed while suppressing bleeding.

### Modification 3 of Second Embodiment

In Modification 3, the position of the head is moved in accordance with the print data of the regions. This modification is identical to the previously described Modification 2 (FIG. 12D) until the maximum times of the inks are determined. In this case, the total of the maximum times is 11 seconds (=1+3+3+4), and the paper is conveyed the total length of 40 inches in 11 seconds. Consequently, the conveying speed is 40 (inch)/11 (sec)=36.4 (cps). Since the necessary times between the heads are known, the intervals between the heads are determined from these conveying speeds.

For example, since the maximum time between the black ink head K and the cyan ink head C is 1 second, the interval between these heads is preferably 36.4 (cps)×1 (sec)=3.6 (inch). Since the maximum time between the cyan ink head C and the magenta ink head M is 3 seconds, for example, the interval between these heads is preferably 36.5 (cps)×3 (sec)=10.9 (inch). Thus, the optimal head intervals can be set from the print data of the regions.

In the present embodiment, the positions of the heads are moved, but a plurality of nozzle rows may be aligned on the heads in the conveying direction, and the nozzle rows that are used by the heads may be varied based on the print data.

### Modification 4 of Second Embodiment

In the previously described embodiments, a line printer was used, but Modification 4 of the second embodiment uses a printer (a so-called serial printer) which prints an image on a medium by repeatedly performing a conveying action for conveying the medium in a conveying direction and a dot-forming action (also referred to as a “pass” hereinbelow) for discharging ink and forming dots while moving the heads in a direction (the movement direction) that intersects the conveying direction.

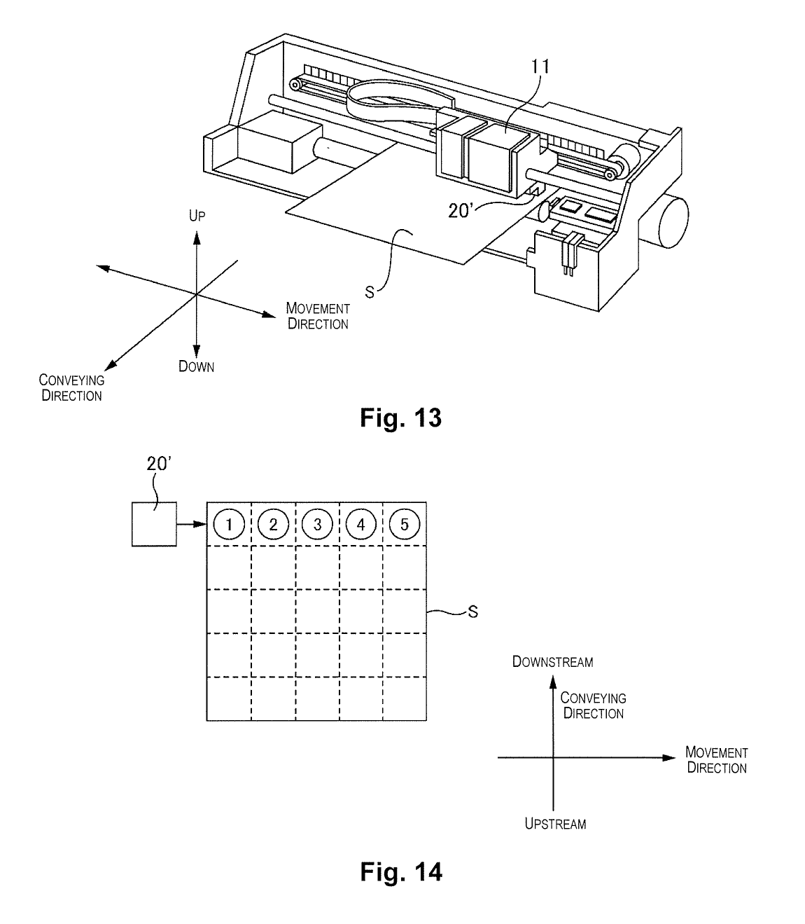

FIG. 13 is a perspective view of the printer (a serial printer) of Modification 4 of the second embodiment.

A carriage 11 is capable of moving back and forth in the movement direction, and is driven by a carriage motor (not shown). In the carriage 11, ink cartridges which store ink are detachably held. In the present embodiment, the carriage 11 is equivalent to the movement mechanism.

A head unit 20′ has a plurality of heads for discharging ink, and the head unit 20′ is provided to the carriage 11. The head unit 20′ of Modification 4 comprises a plurality of heads arranged in alignment in the movement direction for each ink color, and the heads have nozzle rows in which pluralities of nozzles are aligned in the conveying direction.

Therefore, when the carriage 11 moves in the movement direction, the head unit 20′ also moves in the movement direction. The head unit 20′ intermittently discharges ink from the nozzle rows of the heads while moving in the movement direction, whereby dot lines (raster lines) are formed on the medium along the movement direction.

FIG. 14 is a drawing for describing the action in Modification 4 of the second embodiment.

In this Modification 4, first, during each pass, the discharge duty is determined for the inks of the head unit 20′ onto regions (region 1 through region 5) running along the movement direction. The speeds of the passes are varied according to the discharge duties of inks from the heads of each color, similar to the embodiments previously described. In the previous embodiments, the conveying times were optimized, but in this Modification 4, the movement time of the head unit 20′ in the movement direction is optimized. The method of optimization is identical to that of the line printer (the case of optimizing the conveying time). The pass time can thereby be reduced, and printing speed can be improved.

The positions of the different colored heads (their positions in the movement direction in this case) and the positions of the nozzles rows (their positions in the movement direction) for discharging ink may be varied according to the ink discharge duty, similar to the embodiments previously described.

### Third Embodiment

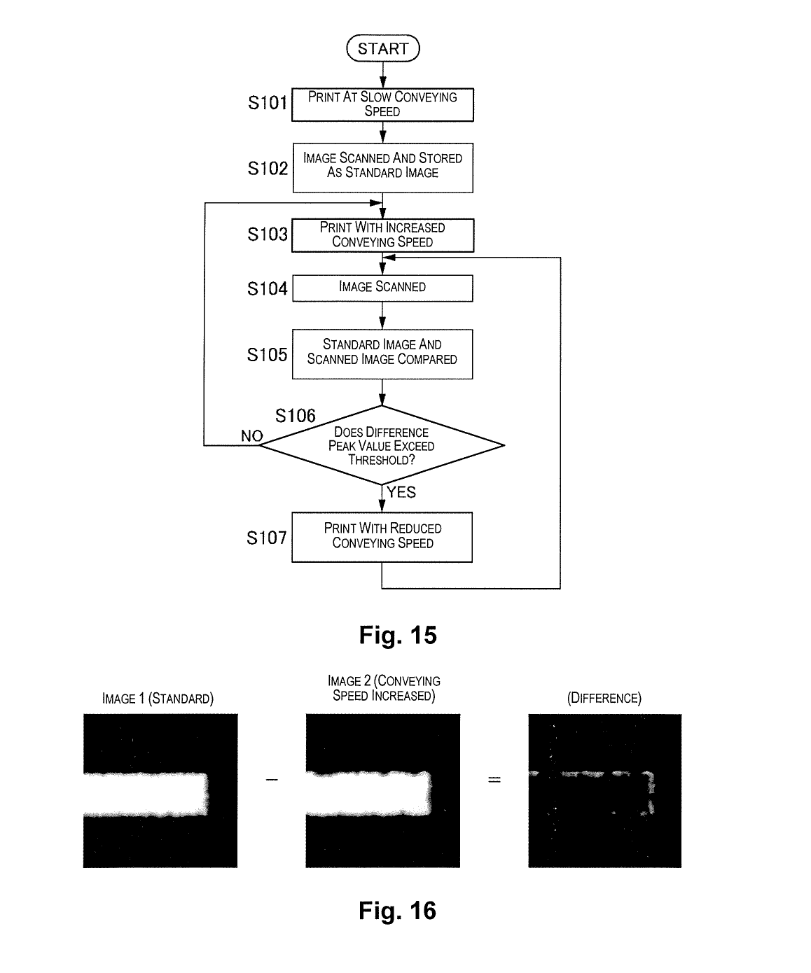

FIG. 15 is a flowchart of the optimization of the conveying speed of the third embodiment.

This optimization process is performed when printing is actually performed after the distances between heads and the conveying speeds have been adjusted according to the previous embodiments. The adjusting of the head intervals and conveying speeds on the basis of the print data is the same as the previous embodiments and is therefore not described here.

First, with the first paper P, when the ink discharged from the heads is deposited on the paper S, printing is performed (S101) at a slow conveying speed (hereinbelow referred to as the reference speed, e.g. 25 cps) such that the ink discharged from the heads upstream in the conveying direction reliably dried. The computer 110 then scans the printed image with the scanner 120 at the reference speed, and stores the scanned image (hereinbelow also referred to as the standard image) in the memory 113 (S102).

Printing is performed on the next paper S with the conveying speed increased above the reference speed (for example, at 50 cps) (S103). After printing, the printed image is scanned by the scanner 120, similar to the first paper S (S104).

The computer 110 then compares the scanned image obtained by this scan and the standard image stored in the memory 113 (S105).

FIG. 16 is an explanatory diagram of the comparison of the scanned images.

The image 1 in this diagram is the scanned image (the standard image) of the image printed at the reference speed. In this case, there is no blurring between different ink colors because sufficient drying time is taken due to the conveying speed being slow. The image 2 is a scanned image of the image printed with the conveying speed increased above the reference speed. The images are printed in two different colors (white and black in the diagram).

When the differences between each pixel (difference in tone value) are found between image 1 and image 2, the result is the image on the right of the diagram. If there is no bleeding in image 2, there will be no difference in tone value of the pixels of the difference images (the tone value will be substantially the same). However, in the difference image of FIG. 16, the color (tone value) in the border portions of the colors in images 1 and 2 is different from that of the rest of the image. Specifically, it can be seen that bleeding is occurring in this portion in image 2.

In this manner, the computer 110 determines the difference for each pixel in the read results of the scanner 120 for the two images printed at different conveying speeds. The peak value (maximum value) of these differences is calculated.

The computer 110 then determines whether or not the calculated difference peak value exceeds a threshold (S106). If the difference peak value does not exceed the threshold (NO in S106), the process returns to step S103, the conveying speed is further increased, and the next printing is performed.

Hereinbelow, the same action is repeated, and if the peak value exceeds the threshold in step S106 (YES in S106), the conveying speed is reduced to below this conveying speed, the next printing is performed (S107), and the process returns to step S104.

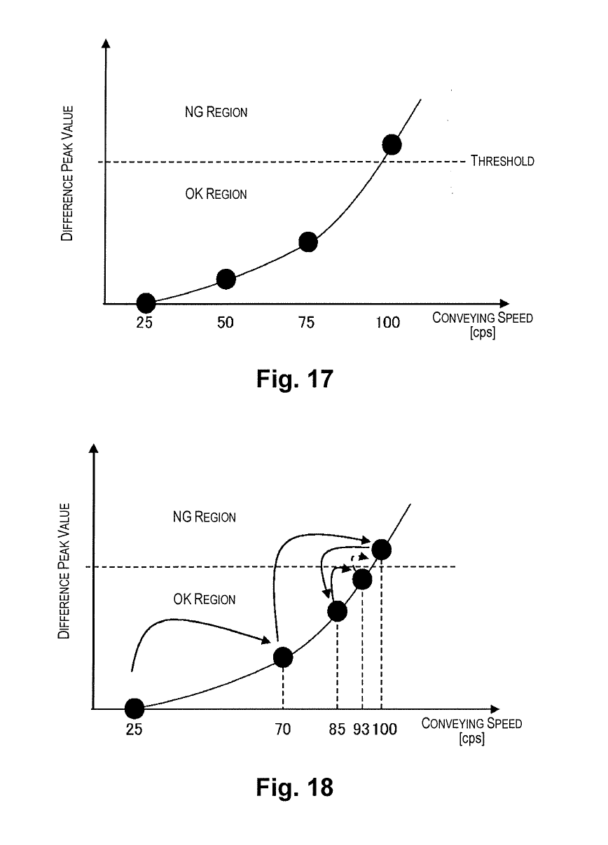

FIG. 17 is a diagram showing an example of a change in the conveying speed. In the present embodiment, the conveying speed is changed by a specified amount (hereinbelow referred to as “step width”). The horizontal axis in the graph represents the conveying speed, and the vertical axis represents the difference peak. The dotted line in the graph is the threshold.

At a conveying speed of 50 cps, the difference peak value does not exceed the threshold as shown in the graph, and printing is therefore performed on the next paper S with the conveying speed further increased by 25 cps to a conveying speed of 75 cps. The difference peak value does not exceed the threshold value in this case as well. Consequently, the conveying speed is further increased by 25 cps for the next paper S and printing is performed at a conveying speed of 100 cps.

When printing has been performed at a conveying speed of 100 cps, the difference peak value exceeds the threshold as shown in the graph. In other words, there is a high possibility that bleeding will occur in the printed image. Consequently, printing is performed on the next paper S with the conveying speed reduced to the first previous speed (75 cps).

It is preferable to prepare different thresholds depending on the type of paper S used for printing. For example, since regular paper has large variations with each paper, the threshold is increased, and since inkjet-specialized paper has an ink-absorbing layer and small variation with each paper, the threshold is preferably reduced.

In the present embodiment, an evaluation is made as to whether or not the maximum value of the difference between each pixel of the two images exceeds a threshold, but the evaluation may be made by other methods. For example, the evaluation may be of the number of pixels in which the size of the difference between the two images is equal to or greater than a specified value. Specifically, the evaluation can be whether or not the result of comparing the two images is within an allowable range (within allowable values).

Thus, in the present embodiment, the conveying speed can be optimized while suppressing bleeding regardless of the type of paper S and combination of inks and without making an evaluation using a test pattern. According to the present embodiment, the conveying speed can be optimized automatically.

### Modification 1 of Third Embodiment

FIG. 18 is a diagram showing an example of the relationship between conveying speed and the difference in Modification 1 of the third embodiment. In this graph, the horizontal axis represents the conveying speed and the vertical axis represents the difference peak value. The dotted line in the graph is the threshold.

In the third embodiment, the step width of the conveying speed was specified (25 cps), whereas in Modification 1, at first the step width is large, and the step width then progressively decreases. In other words, the conveying speed is varied incrementally.

Specifically, first, printing is performed at a slow conveying speed (a reference speed of 25 cps) so that bleeding reliably does not occur, and the scanned image (standard image) is stored in the memory 113 of the computer 110.

Printing is performed on the next paper S with a conveying speed of 70 cps (increased by 45 cps). According to FIG. 18, the difference peak value in this case does not exceed the threshold. In view of this, printing is performed on the next paper S with a conveying speed of 100 cps (increased by 30 cps).

However, when printing is performed at 100 cps, the difference peak value exceeds the threshold as shown in FIG. 18.

In view of this, printing is performed on the next paper S with a conveying speed of 85 cps (reduced by 15 cps). The difference peak value then falls below the threshold. Consequently, printing is performed on the next paper S with a conveying speed of 93 cps (increased by 8 cps).

In cases in which the conveying speed can be varied in numerous steps, an optimal printing speed can be achieved even sooner by incrementally changing the conveying speed as in the present embodiment.

### Modification 2 of Third Embodiment

In Modification 1 previously described, the step width decreased progressively, but in this Modification 2, the relationship between the size of the difference and the step width is established in advance, and the step width is varied according to the size of the difference.

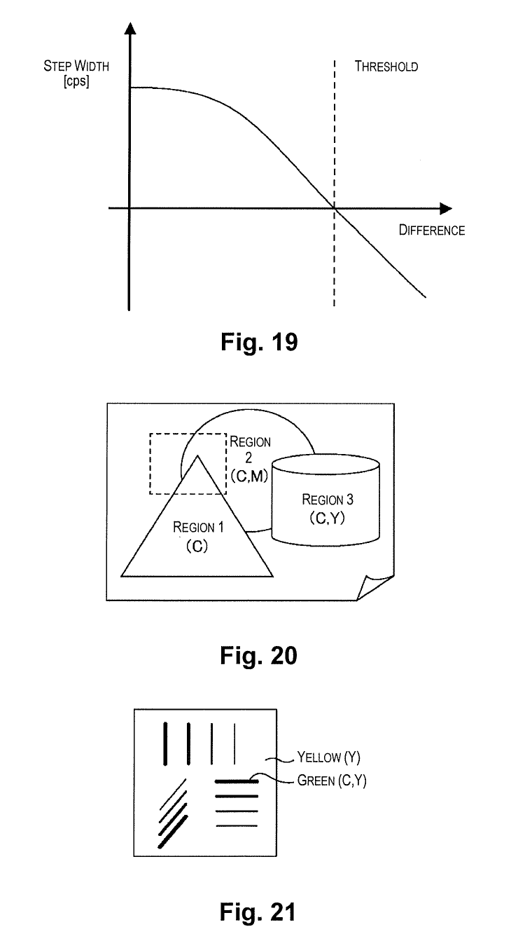

FIG. 19 is a graph showing an example of the correlation between the size of the difference and the step width in Modification 2 of the third embodiment. The horizontal axis of the graph represents the size of the difference (equivalent to the vertical axes of FIGS. 17 and 18), and the vertical axis represents the step width. The dotted line in the graph shows the threshold (equivalent to the thresholds in FIGS. 17 and 18). In this Modification 2, the data representing the relationship of FIG. 19 is stored in advance in the memory 113 of the computer 110, for example.

In this Modification 2, the computer 110 refers to the data of FIG. 19 and establishes the conveying speed after determining the difference of the images in the same manner as the embodiments previously described.

For example, the step width of the conveying speed is increased when the value of the difference is fairly smaller than the threshold. Specifically, the next printing is performed with a greatly increased conveying speed (an increased step width). When the value of the difference is near the threshold, the next printing is performed with a slightly increased conveying speed (an increased step width). The step width is zero when the value of the difference and the threshold are equal. Specifically, the next printing is performed without varying the conveying speed.

When the difference exceeds the threshold, the step width reaches a negative value. In this case, the next printing is performed with a reduced conveying speed.

The number of printings at the slow conveying speed can thereby be reduced, and the optimal conveying speed can be established sooner.

### Modification 3 of Third Embodiment

In the embodiments previously described, the entire image printed on the paper S is scanned with the scanner 120. However, in this case, the scanning time is long and there is a large amount of data for the scanned image.

In view of this, in this Modification 3, only a partial region of the image is scanned, rather than the entire image, to determine whether or not there is bleeding.

FIG. 20 is a drawing showing an example of a printed image in Modification 3 of the third embodiment. In FIG. 20, region 1 is printed in cyan, region 2 is printed in blue (a mixture of cyan and magenta), and region 3 is printed in green (a mixture of cyan and yellow).

In this case, scanning the portion susceptible to blurring (e.g. the portion enclosed by the dotted lines in the drawing) makes it possible to reduce scanning time to below that of scanning the entire image. At this time, bleeding can be effectively suppressed by selecting the portion of the image that is susceptible to bleeding.

Thus, by selecting part of the image to scan rather than scanning the entire image, the scanning time can be reduced. Consequently, the next printing can be performed sooner and the optimal conveying speed can be established sooner. The capacity for storing the scanned image in the memory 113 of the computer 110 can also be reduced.

A bleeding evaluation pattern such as the one shown in FIG. 21 may be printed on the end of the paper S, for example, and this evaluation pattern may be scanned alone by the scanner 120. FIG. 21 is a drawing showing an example of a bleeding evaluation pattern.

A plurality of ruled lines differing in thickness are printed in a vertical direction, a horizontal direction, and a diagonal direction in the bleeding evaluation pattern shown in FIG. 21. The ruled lines and the portions other than the ruled lines are printed in different colors. For example, the ruled lines are printed in green (a mixture of cyan and yellow), and the rest besides the ruled lines is printed in yellow (solid printing). Bleeding between the yellow and cyan can be efficiently evaluated by printing such a pattern on part of the paper S. Patterns of other colors (e.g., cyan and magenta, or magenta and yellow) may be created in the same manner.

Thus, in Modification 3, part of the image is scanned rather than scanning the entire image. An optimal conveying speed can thereby be established sooner.

### Other Embodiments

A printer or the like was described as an embodiment, but the embodiment described above is intended to make the present invention easier to understand and is not to be interpreted as limiting the present invention. The present invention can be altered and improved without deviating from the scope thereof, and it shall be apparent that equivalents thereof are included in the present invention. Particularly, even the embodiments described below are included in the present invention.

### Liquid Discharge Device

In the embodiments previously described, an inkjet printer is described as an example of a liquid discharge device. However, the liquid discharge device is not limited to an inkjet printer, and can also be specified as a liquid discharge device which discharged a fluid other than ink (a liquid, a liquid-like substance in which particles of a functional material are dispersed, or a fluid such as a gel). For example, the above-described embodiments and similar technologies may be applied to various devices which apply inkjet technology, such as color filter manufacturing devices, dyeing devices, micromachining devices, semiconductor manufacturing devices, surface treatment devices, three-dimensional molding devices, gas vaporizer devices, organic EL manufacturing devices (particularly macromolecular EL manufacturing devices), display manufacturing devices, film-forming devices, and DNA chip manufacturing devices, for example. The methods and manufacturing methods of these devices are also categorized in the applicable range.

### Ink

Since the previously described embodiments are embodiments of a printer, ink is discharged from nozzles, and the ink may be water-based or oil-based. The liquid discharged from the nozzles is not limited to ink. For example, a liquid (including water) containing a metal material, an organic material (particularly a macromolecular material), a magnetic material, an electroconductive material, a wiring material, a film-forming material, electronic ink, a machining liquid, a genetic solution, or the like may be discharged from the nozzles.

### Ink Discharge System

The ink discharge system for discharging ink from nozzles in the printer 1 may be a piezo system in which ink chambers are expanded and contracted by the driving of piezo elements, or a thermal system in which heat-generating elements are used to create air bubbles in the nozzles and ink is discharged by these air bubbles.

### Scanner

In the embodiments described above, the scanner 120 was a sensor system which had sensors (e.g., CCD) of R, G, and B, wherein R, G, and B information was acquired by reading the reflection of light radiated onto a manuscript by the sensors, but the scanner is not limited to this system. For example, a light source switching system may be used in which a fluorescent lamp of the colors R, G, and B is switched on and off, the reflected light is read by a monochrome image sensor, and information of the colors R, G, and B is acquired; or a filter switching system may be used in which R, G, and B color filters are provided between the light source and the sensors, and information of the colors R, G, and B is acquired by sequentially switching these color filters.

A sensor may also be provided downstream in the conveying direction from the head, and the image may be read by the sensor while the paper S after printing is conveyed in the conveying direction.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A printing device comprising:
a plurality of heads configured to print an image on a medium by discharging colored inks onto the medium, the heads discharging the inks at different positions in a predetermined direction;
a movement mechanism configured to move the medium and the heads in the predetermined direction relative to each other; and
a calculation unit configured to determine respective discharge amounts of ink discharged from each of the heads when the image is printed,
a position in the predetermined direction, in which the inks are discharged from the heads, being varied based on the discharge amounts determined by the calculation unit.

2. The printing device according to claim 1, wherein
each of the heads has a plurality of nozzle rows each including a plurality of nozzles aligned in a direction intersecting the predetermined direction, the nozzle rows being aligned in the predetermined direction, and
the nozzle rows used to discharge the inks in the heads are varied based on the discharge amounts determined by the calculation unit.

3. The printing device according to claim 1, wherein
a speed of a relative movement between the medium and the heads is varied based on the discharge amounts determined by the calculation unit.

4. The printing device according to claim 1, wherein
the calculation unit calculates the discharge amount of ink discharged by each of the heads in each of a plurality of regions of the medium, and
a position in the predetermined direction where the inks are discharged from each of the heads is varied according to the discharge amount of ink discharged in each of the regions.

5. The printing device according to claim 1, further comprising
a reading unit configured to read an image printed on the medium by the heads with the medium being conveyed in the predetermined direction and the inks being respectively discharged from the heads onto the medium being conveyed, and
a comparison unit configured to compare an image reading result when the medium is conveyed at a reference speed until ink discharged from one of the heads lands on the medium, and an image reading result when the medium is conveyed at a first conveying speed that is higher than the reference speed, the reference speed being a speed at which ink discharged from another head upstream from the one of the heads in the predetermined direction dries,
a subsequent printing being performed at a second conveying speed that is lower than the first conveying speed when the results of the comparison made by the comparison unit have exceeded an acceptable value.

6. The printing device according to claim 1, further comprising
a reading unit configured to read an image printed on the medium by the heads with the medium being conveyed in the predetermined direction and the inks being respectively discharged from the heads onto the medium being conveyed, and
a comparison unit configured to compare an image reading result when the medium is conveyed at a reference speed until ink discharged from one of the heads lands on the medium, and an image reading result when the medium is conveyed at a first conveying speed that is higher than the reference speed, the reference speed being a speed at which ink discharged from another head upstream from the one of the heads in the predetermined direction dries,
a subsequent printing being performed at a second conveying speed that is higher than the first conveying speed when the results of the comparison made by the comparison unit have exceeded an acceptable value.

7. The printing device according to claim 5, wherein
a magnitude of the second conveying speed is established according to the results of the comparison made by the comparison unit.

8. The printing device according to claim 5, wherein
the reading unit reads a part of the image printed on the medium, and
the comparison unit compares a result of reading a part of the image when the medium is conveyed at the reference speed, and a result of reading a part of the image when the medium is conveyed at the first conveying speed.
